(19) United States
(12) Patent Application Publication
(10) Pub. No.: US 2020/0101536 A1
(43) Pub. Date: Apr. 2, 2020

(54) 3D PRINTING METHOD AND APPARATUS

(71) Applicant: Aurora Labs Limited, Bibra Lake, Western Australia (AU)

(72) Inventor: Malcolm Peter Cook, Bibra Lake, Western Australia (AU)

(73) Assignee: Aurora Labs Limited, Bibra Lake, Western Australia (AU)

(21) Appl. No.: 16/619,819

(22) PCT Filed: Jun. 6, 2018
(86) PCT No.: PCT/AU2018/000090

§ 371 Date: Dec. 5, 2019

(30) Foreign Application Priority Data
Jun. 6, 2017 (AU) 2017902153

(51) Int. Cl. B22F 3/105; B33Y 30/00; B23K 26/06; B23K 26/067; B23K 26/08; B23K 26/14; B23K 26/342

(52) U.S. Cl. CPC B22F 3/1055; B33Y 30/00; B23K 26/0608; B22F 2003/1056; B23K 26/0869; B23K 26/1464; B23K 26/342; B23K 26/0673

(57) ABSTRACT

A printing apparatus for printing a three-dimensional object, including an operative surface; a printing head comprising a frame attached pivotally to at least one control arm, wherein the frame is rotatable about an axis disposed at a point of attachment between the frame and control arm; a plurality of powder dispensers connected at a plurality of positions along the frame, the powder dispensers being configured to deposit multiple layers of powder onto the operative surface simultaneously when the printing head travels relative to the operative surface; and an energy source for emitting at least one energy beam onto at least one layer of powder.

### FIELD OF INVENTION

The present invention relates to a 3D printing method and apparatus.

More particularly, the present invention relates to a 3D printing method and apparatus adapted for manufacturing objects at high speed.

### BACKGROUND

Three-dimensional (3D) printed parts result in a physical object being fabricated from a 3D digital image by laying down consecutive thin layers of material.

Typically these 3D printed parts can be made by a variety of means, such as selective laser melting or sintering, which operate by having a powder bed onto which an energy beam is projected to melt the top layer of the powder bed so that it welds onto a substrate or a substratum. This melting process is repeated to add additional layers to the substratum to incrementally build up the part until completely fabricated.

These printing methods are significantly time consuming to perform and it may take several days, or weeks, to fabricate a reasonable sized object. The problem is compounded for complex objects comprising intricate component parts. This substantially reduces the utility of 3D printers and is one of the key barriers currently impeding large-scale adoption of 3D printing by consumers and in industry.

The present invention attempts to overcome, at least in part, the aforementioned disadvantages of previous 3D printing methods and devices.

### SUMMARY OF THE INVENTION

In accordance with one aspect of the present invention, there is provided a printing apparatus for printing a three-dimensional object, comprising:
an operative surface;
a printing head comprising a frame attached pivotally to at least one control arm, wherein the frame is rotatable about an axis disposed at a point of attachment between the frame and control arm;
a plurality of powder dispensers connected at a plurality of positions along the frame, the powder dispensers being configured to deposit multiple layers of powder onto the operative surface simultaneously when the printing head travels relative to the operative surface; and
an energy source for emitting at least one energy beam onto at least one layer of powder.

The energy source may, in use, emit energy beams onto two or more layers of powder simultaneously.

Alternatively, multiple energy sources may be used to emit at least one energy beam from each energy source.

The energy source may, in use, emit an energy beam onto individual layers of powder in a sequence.

The printing apparatus may comprise an energy beam splitting means for splitting and directing an energy beam into two or more separate energy beams.

In accordance with another aspect of the present invention, there is provided a printing apparatus for printing a three-dimensional object, comprising:
an operative surface;
a printing head comprising a frame, wherein the operative surface and the frame are rotatable relative to one another;
a plurality of powder dispensers connected at a plurality of positions along the frame, the powder dispensers being configured to deposit multiple layers of powder onto the operative surface simultaneously when the printing head travels relative to the operative surface; and
an energy source for emitting at least one energy beam onto at least one layer of powder.

### BRIEF DESCRIPTION OF DRAWINGS

The present invention will now be described, by way of example, with reference to the accompanying drawings, in which:

FIG. 1 is a side view of a 3D printing apparatus according to an embodiment of the invention;

FIG. 2 is a further side view of the 3D printing apparatus of FIG. 1;

FIG. 3 is an elevated isometric view of the 3D printing apparatus of FIG. 1; and

FIG. 4 is a side view of a 3D printing apparatus according to a further embodiment of the invention.

### DETAILED DESCRIPTION OF THE DRAWINGS

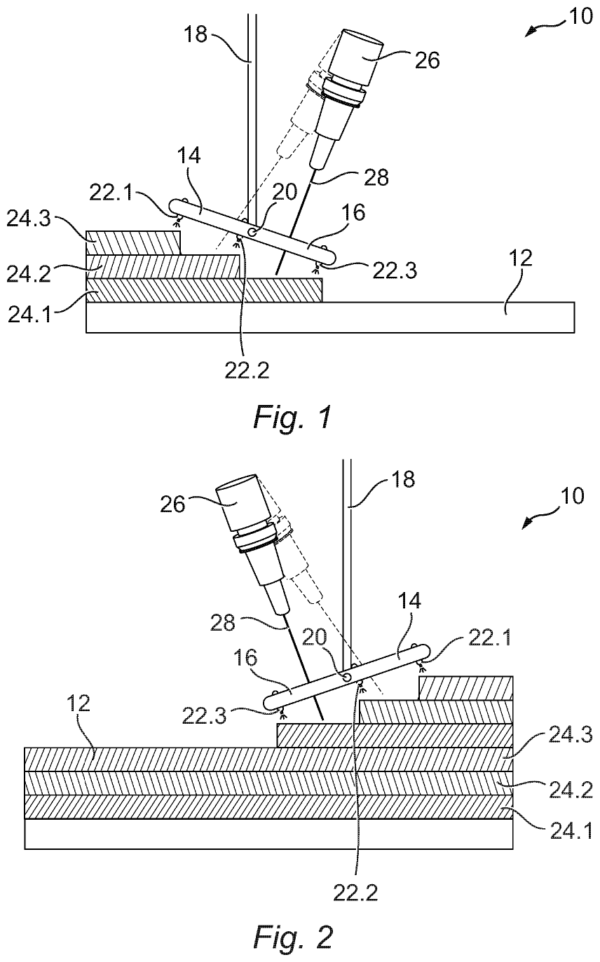

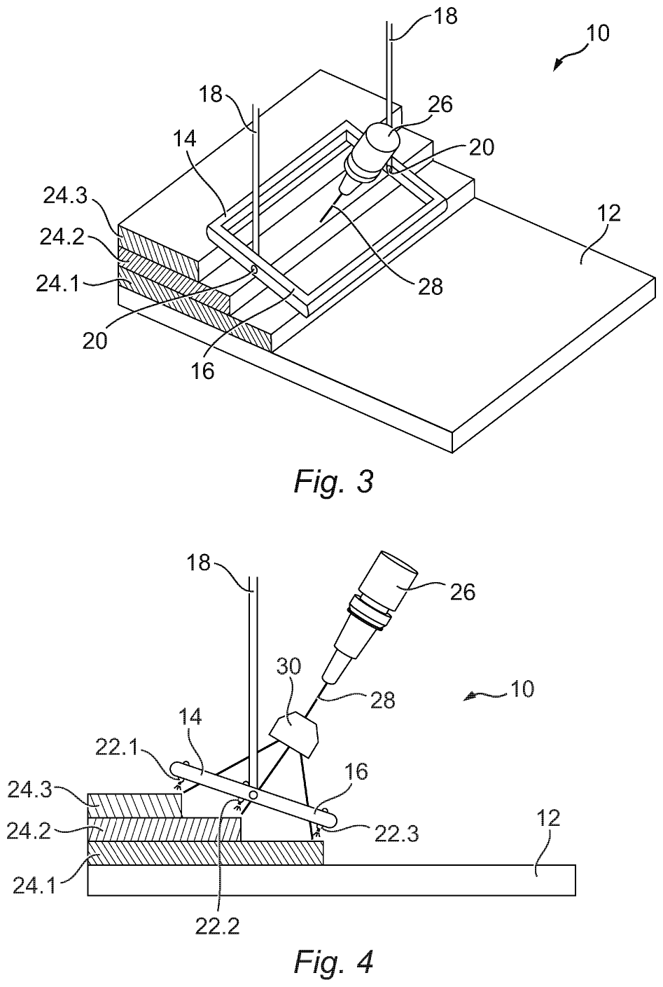

Referring to FIGS. 1 to 3, there is shown a printing apparatus 10 for printing a three-dimensional object according to an embodiment of the invention. The apparatus 10 comprises an operative surface 12 and a printing head 14 comprising a frame 16 attached pivotally to at least one control arm 18, wherein the frame 16 is rotatable about an axis 20 disposed at a point of attachment between the frame 16 and control arm 18.

The apparatus 10 further comprises a plurality of powder dispensers 22 connected at a plurality of positions along the frame 16, the powder dispensers 22 being configured to deposit multiple layers of powder 24 onto the operative surface 12 simultaneously when the printing head 14 travels relative to the operative surface 12. The apparatus 10 further comprises an energy source 26 for emitting at least one energy beam 28 onto at least one layer of powder 24.

More particularly, a total of three powder dispensers 22 are connected to the frame 16. Each powder dispenser 22 comprises a nozzle affixed to the frame 16 that is connected to a supply of powder, for example metallic powder, via one or more supply tubes (not shown).

The powder dispensers 22 are positioned uniformly on the frame 16 such that they are spaced apart from one another equally. The frame 16 is attached pivotally to a pair of control arms 18 and is configured such that, in use, the frame 16 is tilted about the axis 20 an angle relative to the operative surface 12.

In use, the three powder dispensers 22 simultaneously deposit three layers of powder 24 onto the operative surface 12, each layer 24 having substantially the same thickness. The layers of powder 24 are deposited in a staggered manner such that the formation of each individual layer in the plurality is commenced slightly later that the individual layer of powder immediately beneath it. This ensures that a topmost surface of each layer 24 is, at least in part, exposed and not covered by an overlying layer of powder 24 during the simultaneous application of the layers 24.

The energy beam 28 can be any one of a laser beam, a collimated light beam, a micro-plasma welding arc, an electron beam and a particle accelerator. Preferably the energy beam 28 has focusing means (not shown) being adapted to suitably focus the energy beam 28 so that an energy density being at least 10 Watts/mm³ is produced.

Where the energy beam 28 is a laser beam, the laser beam can be focused onto the operative surface 12 to a spot size of less than 0.5 mm². Similarly, where the energy beam 28 is a collimated light beam, the light beam can be focused onto the operative surface 12 to a spot size of less than 1 mm².

Further, where the energy beam 28 is a micro-plasma welding arc, the micro-plasma welding arc can be focused onto the operative surface 12 to a spot size of less than 1 mm². Such a micro-plasma welding arc is normally able to produce a focused beam of plasma gas at a temperature of about 20,000° C. with a spot size of about 0.2 mm².

In use, the printing head 14 travels back and forth in a lateral direction substantially parallel to the operative surface 12 while depositing powder. For example, in FIG. 1 the printing head 14 is shown travelling from a left side to a right side of the apparatus 10 while the frame 16 is titled at a clockwise angle relative to the operative surface 12. In this configuration, the printing head 14 is shown depositing an initial three layers of powder.

In FIG. 2, the initial three layers of powder have been deposited and worked on by the energy beam 28 in full and the printing head 14 is shown travelling from the right side to the left side of the apparatus 10 while the frame 16 is titled at an anti-clockwise angle relative to the operative surface 12. In this configuration, the printing head 14 is shown depositing a further three layers of powder over the initial three layers.

While the layers of powder 24 are being deposited, the energy beam 28 is emitted from an energy source 26 and directed onto the exposed topmost surfaces of each layer of powder 24 to melt or sinter the powder selectively, thereby forming part of the 3D object. This process is repeated for additional passes to add additional layers and incrementally build up the 3D object until it is completed.

As depicted in FIG. 1, the energy source 26 may be adapted to operate as a raster such that while the plurality of layers of powder 24 are being simultaneously deposited, the orientation of the energy source 26 is adjusted such that the energy beam 28 is directed selectively onto each of the topmost exposed surfaces of the layers 24 in the plurality in a sequential manner.

For example, the energy beam 28 may initially be directed onto a topmost surface of a lowermost layer of powder 24 in the plurality. After the surface has been sufficiently worked on by the energy beam 28, the orientation of the energy source 26 is then adjusted such that a second energy beam 28 is directed onto a topmost surface of the next superjacent layer of powder 28 in the plurality. This is continued until all deposited layers of powder in the plurality, as necessary, have been worked on sufficiently before the next pass is conducted.

In embodiments where the energy source 26 operates as a raster, the energy beam 28 may be applied to each exposed surface of each powder layer, as necessary, for a sufficient period of time such that the powder is heated or energised causing it to melt or sinter before the energy source 26 is re-orientated for the next layer in the plurality.

Alternatively, the energy beam 28 may be applied to each exposed surface of powder for a lesser period of time such that the powder is only partially heated or energised before the energy source 26 is re-orientated for the next layer. In this method, the energy source 26 is cycled repeatedly through the plurality of layers 24 in a rapid manner such that additional energy is applied to each exposed surface on each iteration. This causing the temperature or energy of each surface that is worked on to increase incrementally until it reaches a point at which the powder melts or sinters.

In the embodiment shown in FIGS. 1 to 3, three powder dispensers 22 are affixed to the printing head 14 for depositing three layers of powder 24 onto the operative surface 12 simultaneously. This yields a three-fold increase in printing productivity levels compared to the prior art printing apparatus and methodologies.

It will be appreciated, however, that an alternative number of powder dispensers may be used (for example, ten powder dispensers). More generally, N powder dispensers (where N≥2) may be used for simultaneously depositing N layers of powder, leading to an N-fold increase in printing productivity.

Referring to FIG. 4, there is shown a further alternative embodiment of the printing apparatus 10. The apparatus 10 is identical in all material respects to the one shown in FIGS. 1 to 3 except that printing apparatus 10 further comprises an energy beam splitting means 30.

The energy beam splitting means 30 is configured to split the single energy beam 28 emitted from the energy source 26 into a plurality of separate directed energy beams. The energy beam splitting means 30 operates in conjunction with a control mechanism (not shown) which provides that, in use, each directed energy beam emitted from the energy beam splitting means 30 is directed, simultaneously, onto a different layer of powder 24 being deposited.

The energy beam splitting means 30 may be a beam splitter.

The energy beam splitting means 30 may be an oscillating magnetic field.

Further modifications and variations as would be apparent to a skilled addressee are deemed to be within the scope of the present invention.

In the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

1. A printing apparatus for printing a three-dimensional object, comprising:
an operative surface;
a printing head comprising a frame attached pivotally to at least one control arm, wherein the frame is rotatable about an axis disposed at a point of attachment between the frame and control arm;
a plurality of powder dispensers connected at a plurality of positions along the frame, the powder dispensers being configured to deposit multiple layers of powder onto the operative surface simultaneously when the printing head travels relative to the operative surface; and
an energy source for emitting at least one energy beam onto at least one layer of powder.

2. The printing apparatus according to claim 1, wherein the energy source emits energy beams onto two or more layers of powder simultaneously.

3. The printing apparatus according to claim 1, wherein the energy source emits an energy beam onto individual layers of powder in a sequence.

4. The printing apparatus according to claim 3, wherein the energy beam is applied to each powder layer for a sufficient period of time such that the powder is heated or energized causing it to melt or sinter before the energy beam is applied to the next layer in the plurality.

5. The printing apparatus according to claim 3, wherein the energy beam is applied to each powder layer for a sufficient period of time such that the powder is only partially heated or energized before the energy source is applied to the next layer, so that temperature or energy of each surface is increased incrementally until it reaches a point at which the powder melts or sinters.

6. The printing apparatus according to claim 1, wherein the printing apparatus comprises an energy beam splitting means for splitting and directing an energy beam into two or more separate energy beams.

7. The printing apparatus according to claim 6, wherein the printing apparatus comprises a control mechanism configured to direct each separate energy beam onto a different layer of powder being deposited.

8. The printing apparatus according to claim 6, wherein the energy beam splitting means is a beam splitter.

9. The printing apparatus according to claim 1, wherein the frame is configured to be tilted at an angle when the printing head is travelling in one direction, and wherein the frame is configured to be tilted at a substantially opposed angle when the printing head is travelling in an opposite direction.

10. The printing apparatus according to claim 9, wherein the angle at which the frame is tilted is such that the distance from each power dispenser to each corresponding powder bed is substantially equal.

11. The printing apparatus according to claim 1, wherein the plurality of powder dispensers are equally spaced relative to one another.

12. The printing apparatus according to claim 1, wherein the multiple layers of powder are deposited in a staggered manner such that the formation of each layer in the plurality is commenced after the formation of the layer of powder immediately beneath it.

13. The printing apparatus according to claim 1, wherein each energy beam is selected from a group consisting of a laser beam, a collimated light beam, a micro-plasma welding arc, an electron beam and a particle accelerator.

14. (canceled)
